(19) United States
(12) Patent Application Publication
(10) Pub. No.: US 2015/0356121 A1
(43) Pub. Date: Dec. 10, 2015

(54) POSITION LOCATION-ENABLED, EVENT-BASED, PHOTO SHARING SOFTWARE AND SERVICE

(71) Applicant: COMMACHINE, INC., San Diego, CA (US)

(72) Inventor: Joseph B. Schmelzer, San Diego, CA (US)

(73) Assignee: COMMACHINE, INC., San Diego, CA (US)

(21) Appl. No.: 14/296,243

(22) Filed: Jun. 4, 2014

(51) Int. Cl. G06F 17/30; H04L 29/06

(52) U.S. Cl. CPC G06F 17/30289; G06F 17/30247; G06F 17/30268; H04L 65/403; G06F 17/30424

(57) ABSTRACT

A method for event-based photo sharing that is carried out by an application or program executing on a mobile device such as a smartphone or tablet computer. An event that is defined at least by a geographic perimeter and a timeframe is created and stored. Location and time metadata of a captured image are compared to the geographic perimeter and timeframe of the event. The image is associated with the event when the location metadata and time metadata of the image falls within the geographic perimeter and timeframe of the event.

### BACKGROUND OF THE INVENTION

Photos may be shared online publicly or privately through websites and applications that facilitate the upload and display of images. Users of such websites and applications can view and possibly download photos of other users and, depending on the website or application, may be able to upload and display their own photos. Online photo sharing runs the gamut from small scale individually-operated photoblogs, typically limited to an individual's own photos and subject to limited dissemination, to very large scale online photo sharing and social networking services such as Instagram and Facebook, which literally host hundreds of billions of photos from vast numbers of users with varying degrees of dissemination based on network reach, individual privacy settings and other factors.

Depending on the degree of sophistication of the photo sharing website or service, there is usually at least some type of classification of posted photos. At the most basic level of classification, photos may simply be arranged chronologically. As the level of sophistication increases, photos may be organized into albums or galleries, or categorized by means such as searchable labels or hashtags. Individuals may be labeled or “tagged”, such that images of that individual may be searched across a website and/or particular databases. Camera-equipped smart phones and other mobile digital imaging equipment are now usually equipped with GPS (global positioning system), Wi-Fi or other functionality permitting position or location determination. Thus, photos may be “geotagged”, allowing classification of photos by their location.

With the widespread adoption of smart phones, tablet computers and other mobile devices equipped with cameras/digital imaging equipment that are connected to the Internet, there are often many images captured by multiple individuals at the same event. These images share not only a common location but also a common timeframe. Examples include weddings, concerts, sporting events, reunions or other family functions, celebrity appearances, etc. At such events that involve a common location and timeframe, multiple individuals may capture multiple photographs of the event from multiple vantage points. Photo sharing via smartphones and other networked mobile devices allow such photographs to be shared instantly via social networks such as Instagram, Facebook, etc.

Despite this capability for instantaneous and large scale sharing, however, an individual present at an event but lacking any personal relationship or affiliation with others who are simultaneously capturing images at that event, has no realistic or practical way of efficiently and quickly accessing photos taken by others at the same event.

### SUMMARY OF THE INVENTION

The present invention provides a solution to this problem, and enables individuals at a given event, i.e. a fixed location and timeframe, to share photos captured at that event and to view photos captured by others present at the same event. Images are codified by a taxonomy that includes location metadata and timeframe metadata, thereby facilitating processing of the image to determine whether it should be associated with a particular event, and allowing for easy search and retrieval of photos taken at the event. Images may also be encoded by other metadata such as an event ID, event name and description, etc. to further facilitate classification and retrieval of the images.

One embodiment of the invention is a non-transitory computer-readable storage medium with an executable program stored thereon that instructs a microprocessor to create and store an event that is defined at least by a geographic perimeter and a timeframe; compare location metadata and time metadata of an image to the geographic perimeter and the timeframe of the event; and associate the image with the event when the location metadata and time metadata of the image falls within the geographic perimeter and the timeframe of the event. In one implementation, the executable program is a mobile application executing on a smartphone or tablet computer.

Another embodiment of the invention is a method of photo sharing comprising the steps of storing an event that is defined at least by a geographic perimeter and a timeframe; associating location metadata and time metadata with an image captured by the mobile device; comparing the location metadata and time metadata associated with the image with the geographic perimeter and the timeframe of the event; and associating the image with the event when the location metadata and time metadata of the image falls within the geographic perimeter and the timeframe of the event.

A further embodiment of the invention is a method of event notification comprising the steps of storing an event that is defined at least by a geographic perimeter and a timeframe; comparing location metadata and time metadata received from a mobile device with the geographic perimeter and the timeframe of the event; and notifying the mobile device of the event when the location metadata and time metadata received from the mobile device fall within the geographic perimeter and the timeframe of the event.

According to these and other embodiments of the invention, images captured at an event with a defined geographic perimeter and timeframe are easily shared among the participants of the event. There is no requirement that the participants know each other or have a persistent social connection (i.e. “friend” each other) in order to share images of the event. Thus, the present invention advantageously permits an event to have a much more comprehensive pictorial record than that afforded by an individual with a single image, single vantage point, image capture device, or by a limited number of individuals that happen to be socially connected sharing pictures among themselves. All photos taken of the event can be accessed, including photos taken by others that were missed by a user, photos taken from different angles and times (within the timeframe of the event), and photos of the user himself/herself that were taken by others.

Other features and advantages of the invention will be apparent from the following detailed description, taken in conjunction with the accompanying drawings that illustrate, by way of example, various features of the invention.

### BRIEF DESCRIPTION OF THE DRAWINGS

FIG. 1 is a block diagram of an exemplary mobile device on which the application software of the present invention may be stored and executed.

FIG. 2 is a system level flow chart of the method executed by the mobile application of the present invention.

FIG. 3 is a block diagram of an object including an image and metadata according to the present invention.

FIG. 4 is a block diagram showing the metadata of FIG. 3 in more detail.

FIG. 5 is a flow chart of the method for event creation executed by the mobile application of the present invention.

FIG. 6 is a conceptual diagram showing an event boundary or perimeter according to the present invention.

FIG. 7 is a block diagram showing an exemplary smartphone user interface for creating an event boundary or perimeter according to the present invention.

FIG. 8 is a block diagram showing an exemplary smartphone user interface for inputting event details according to the present invention.

FIG. 9 is a table showing exemplary event categories and sub-categories according to the present invention.

FIG. 10 is a flow chart of the method for user authentication and registration executed by the mobile application of the present invention.

### DETAILED DESCRIPTION OF THE INVENTION

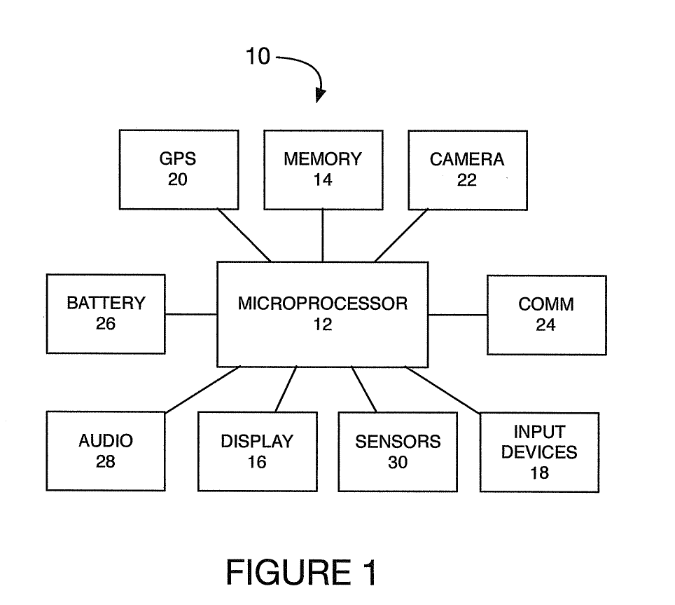

The present invention provides a system and method of position location-enabled, event-based photo sharing. The various methods and process described herein are implemented as an executable computer program or software stored in a non-transitory computer-readable storage medium that is executed by a microprocessor operating in a computing environment. In one embodiment of the invention, the computer program or software is implemented as a mobile application (“app”) that is stored in the memory of a mobile device and that is executed by a microprocessor running on the mobile device. The mobile device may be, for example, a smartphone, tablet computer or other mobile device. FIG. 1 is a block diagram of a mobile device 10 such as a smart phone on which the application software of the present invention may be stored and executed.

Mobile device 10 may include, without limitation, a microprocessor or central processing unit (CPU) 12 and memory 14. Memory 14 may be any non-transitory computer-readable storage medium such as, without limitation, RAM (random access memory), DRAM (dynamic RAM), ROM (read only memory), magnetic and/or optical disks, etc. Memory 14 may be configured and partitioned in various known fashions. Generally speaking, memory 14 typically includes a static component (such as ROM) where the mobile phone operating system (Android or iOS, for example) and system files are stored, as well as additional storage for mobile applications (“apps”) that are executed by microprocessor 12, image files, and other data such as music files, utilities, etc. Memory 14 also typically includes a non-static and faster access portion (such as DRAM) where critical files that need to be quickly accessed by microprocessor 12 (such as operating system components, application data, game graphics, etc.) are temporarily stored. Memory 14 may also comprise a user removable storage device such as an SD (secure digital) card that expands the storage space available on mobile device 10 for applications, image files, sound files, etc.

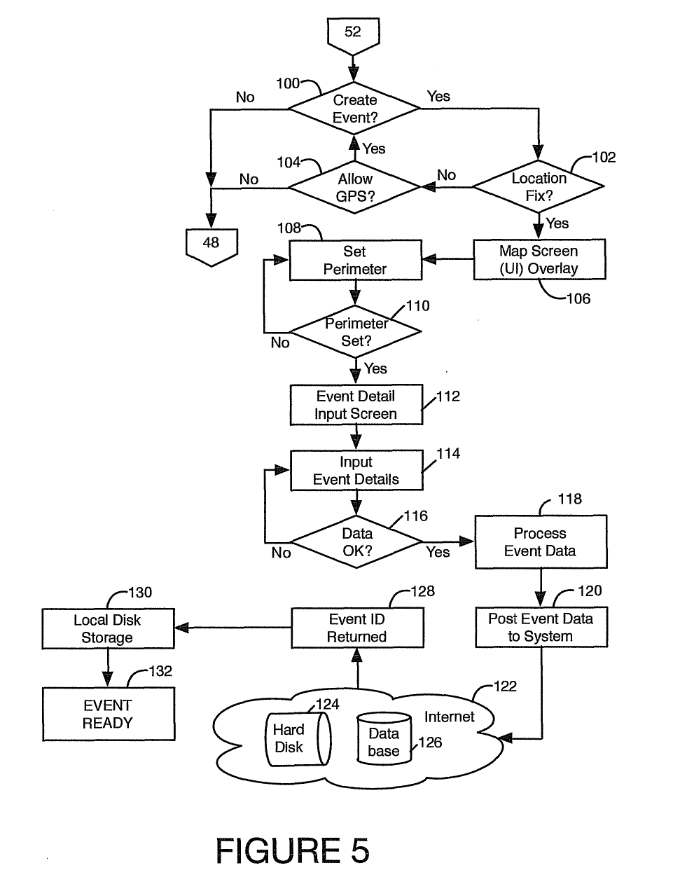

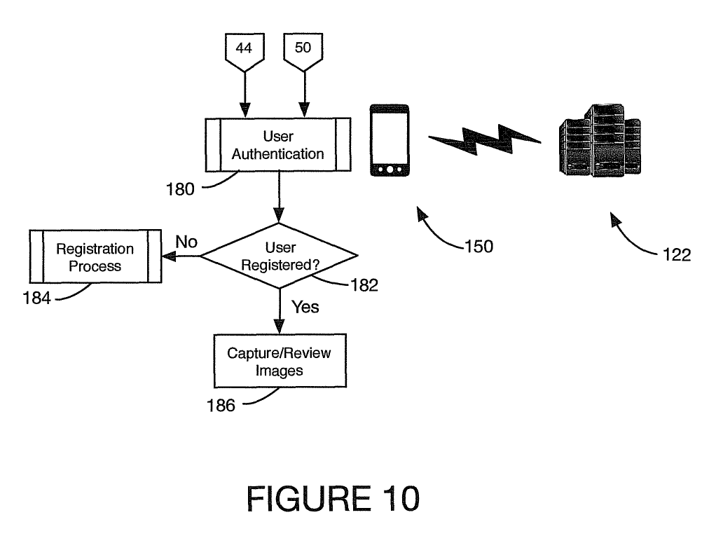

Mobile device 10 also includes a display 16, preferably a touch screen, and additional user input devices 18 such as buttons, keys, etc. Mobile device 10 further includes a GPS (global positioning system) unit 20, and camera 22. GPS unit 20 provides the position and location information described below, while camera 22 captures digital image files that are stored in memory 14 together with metadata, which is also described in further detail below. Mobile device 10 further includes communication components 24 that permit device 10 to exchange voice communications and data with other devices, establish Internet, Wi-Fi and Bluetooth connections, and so on, including the exchange of data and images with server 122 (FIGS. 5, 10) as discussed in detail below. Power is supplied to mobile device 10 via battery 26. Device 10 also includes audio output or speaker 28, and various sensors 30 such as motion detectors, accelerometers, gyroscopes, etc.

Mobile device 10 is merely one exemplary framework of a computing environment in which the present invention may be implemented, and may include different, additional or fewer components and functionality than that illustrated in FIG. 1. The present invention may be implemented in any suitable computing environment including smart phones, tablet computers, digital imaging equipment, personal computers and the like.

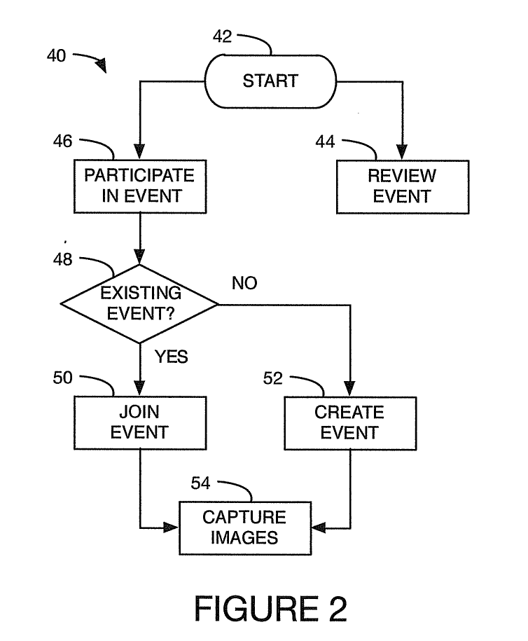

FIG. 2 is a system level flowchart of the method executed by the mobile application of the present invention. As described above, in one embodiment, method 40 of FIG. 2 is implemented as a mobile application or program stored in a memory and executed by a microprocessor on a smartphone, tablet computer or other mobile device, such as mobile device 10 of FIG. 1. In the initial step 42, input is obtained from a user as to whether the user would like to review images associated with an existing (ongoing or concluded) event (step 44), or to participate in (take images of) a new event (step 46). If the user opts to participate in a new event, a determination is made in step 48 of whether the user would like to join an existing (upcoming or ongoing) event (step 50), or would like to create a new event (step 52). Once the user has either joined an existing event or created a new event, the user and other participants in the event may begin to capture images associated with that event in step 54.

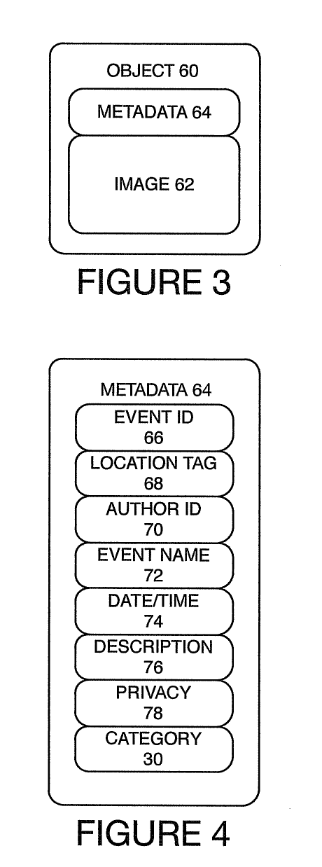

As shown in FIGS. 3 and 4, images 62 captured by a participant in an event are associated with metadata 64 that provides identifying information about the event. Image 62 may be obtained, for example, by camera 22 of mobile device 10, or by any other image capture device with networking capability. Image 62 may be a JPEG file, TIF file or any other digital image file format. Image 62 and its associated metadata 64 may be stored together as an object 60. The captured image and its associated metadata may be stored in memory 14 of mobile device 10, and are also transmitted for storage to a database of a server (preferably cloud-based), such as database 126 of server 122, as shown in FIGS. 5 and 10. In this manner, images 62 are searchable and retrievable by other networked users of the application program that are authorized to access the event.

As illustrated in more detail in FIG. 4, metadata 64 includes various identifiers, tags and descriptors that enable classification of the image 62 by information related to the event at which it was captured. For example, metadata 64 may include event ID 66, location tag 68, author ID 70, event name 72, date and time 74, description 76, privacy setting 78, and category 80. A user can search for and retrieve photos of a particular event by providing one or more of these items of metadata.

FIG. 5 is a flowchart of the steps associated with creating a new event (i.e. step 52 of FIG. 2). In step 100, the system confirms whether the user would like to create a new event. If not (step 100-No), the method retreats to step 48 of FIG. 2, allowing the user the option of joining an existing event. If the user would like to create an event (step 100-Yes), the method proceeds to step 102 to obtain the current location/position of the user. If the current location/position of the user cannot be obtained (step 102-No), the method proceeds to step 104 whereby the user is asked to take appropriate steps to allow position/location determination by GPS or other means. The user may be asked to adjust the settings of his smartphone or other GPS-enabled device to permit location/position determination, or may be asked to move to a location within the event perimeter that is better suited for satellite, Wi-Fi or other connectivity to allow position/location determination. If the user makes appropriate adjustments to allow GPS/position determination (step 104-Yes), the method returns to step 100 to create the event and step 102 to obtain a location fix. If the user cannot make appropriate adjustments to permit GPS/position connectivity (step 104-No), the user may opt to join an existing event in step 48 of FIG. 2, or exit the system.

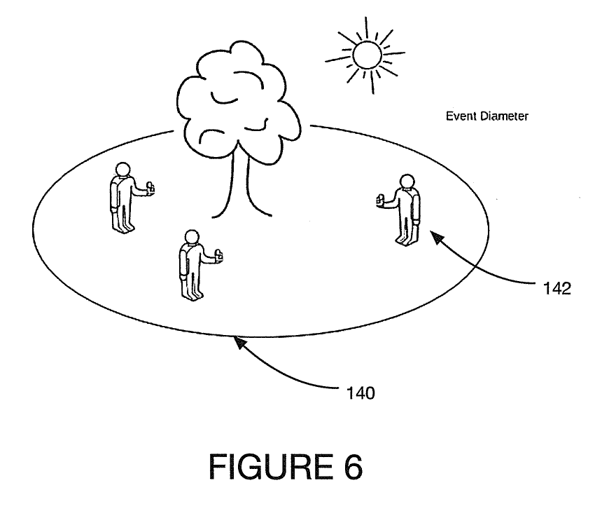

Once location/position is obtained (step 102-Yes), a map screen overlay is displayed on the user interface (UI) of the user's smartphone or other mobile device (step 106), and the user is invited to set the geographic perimeter or boundary of the event (step 108). In other words, the user sets the geographic boundaries within which the event will occur. FIG. 6 is a conceptual diagram showing a user-set geographic periphery or boundary 140 of an event. Images captured by authorized users 142 within periphery 140 and during the defined timeframe of the event will be tagged with metadata 64 about the event as described above, thereby facilitating sharing of their photos with other participants in the event, as well as accessing photos taken by other participants in the event.

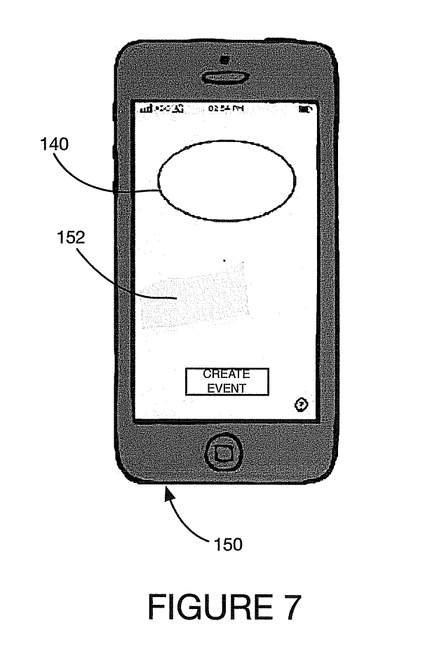

FIG. 7 is a block diagram of an exemplary smartphone device 150 (such as mobile device 10 of FIG. 1) including a user interface 152 for creating user-defined boundary 140. If user interface 152 is a touch screen, boundary 140 may be created by the user tracing a finger on the screen to define boundary 140. Alternatively, boundary 140 may be created by manipulation of a mouse/keyboard, or by operation of any other suitable input device.

Although FIGS. 6 and 7 depict an “event” as being encompassed by a single geographic perimeter or enclosure, an event may alternatively be defined as including multiple geographic perimeters, possibly occurring over multiple timeframes. For example, a wedding may include both the geographic perimeter of a church or other location at which the wedding ceremony takes place, as well as the geographic perimeter of another location within which the reception or celebration following the wedding ceremony takes place. The timeframes associated with such multiple geographic perimeters may be individually set, and may be exclusive or may overlap. As another example, a company or organization with multiple holiday parties across multiple offices may define the “event” to include the geographic boundaries of each individual party, as well as the timeframe of that party, thereby allowing a participating member of one office party of the organization to view photos taken at all other holiday parties of the organization. As yet another example, the event could be a concert tour, including multiple geographic boundaries and timeframes of individual concerts within the tour, searchable by individual concert or the tour as a whole. The key aspect is the combination of geographic boundaries and defined timeframes, which allows for limitless possibilities.

Referring again to FIG. 5, once the geographic boundary or perimeter 140 is set (step 110-Yes), as described above, the method proceeds to step 112 to display a screen inviting the user to input additional details of the event, that is, details of the event in addition to the geographic boundaries of the event. If perimeter 140 is not yet set (step 110-No), the method returns to step 108 to allow the user to complete selection/setting of the event boundary or periphery.

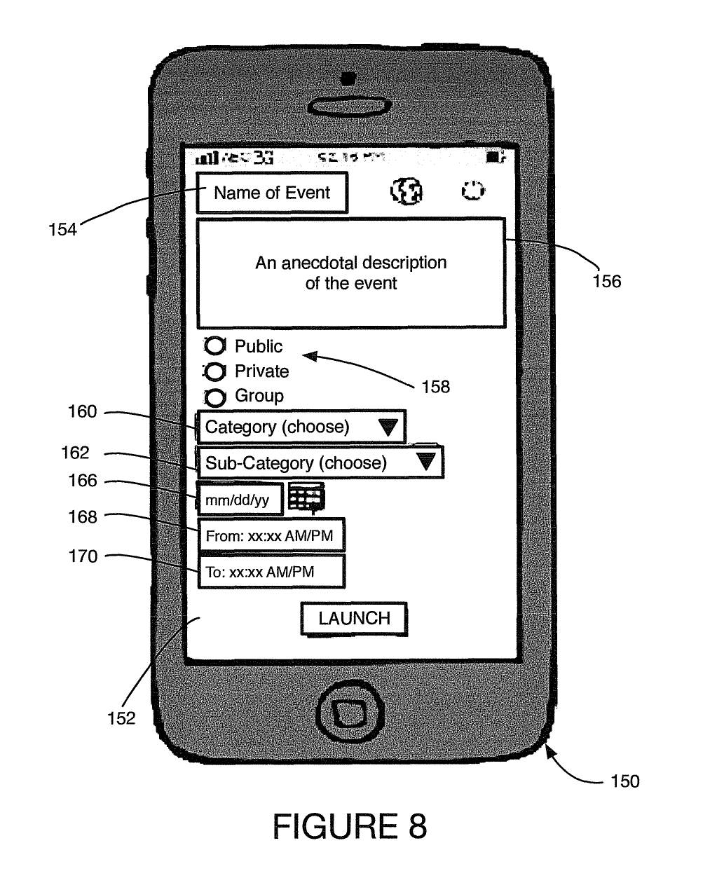

FIG. 8 is an example of the various types of information or event details that a user of smartphone device 150 (or other mobile device) may be invited to input via user interface 152 concerning an event being created by the user. The event details may include the name 154 of the event as well as a description 156 (possibly limited to a certain number of characters) of the event. The user may designate the event (see area 158) as being public (i.e. to encompass any image taken within the geographic boundary and defined timeframe of the event), as being private (i.e to encompass only those images taken within the geography boundary and defined timeframe of the event, and by invited or authorized participants of the event) or as being limited to a particular group (i.e. to encompass only those images taken within the geographic boundary and defined timeframe of the event, and fitting within a defined sub-group of those images, such as “all registered participants”, “only concert goers with VIP access”, “only members of the wedding party”, or any other sub-group within the overall group of all images taken within the geographic boundary during the defined timeframe.

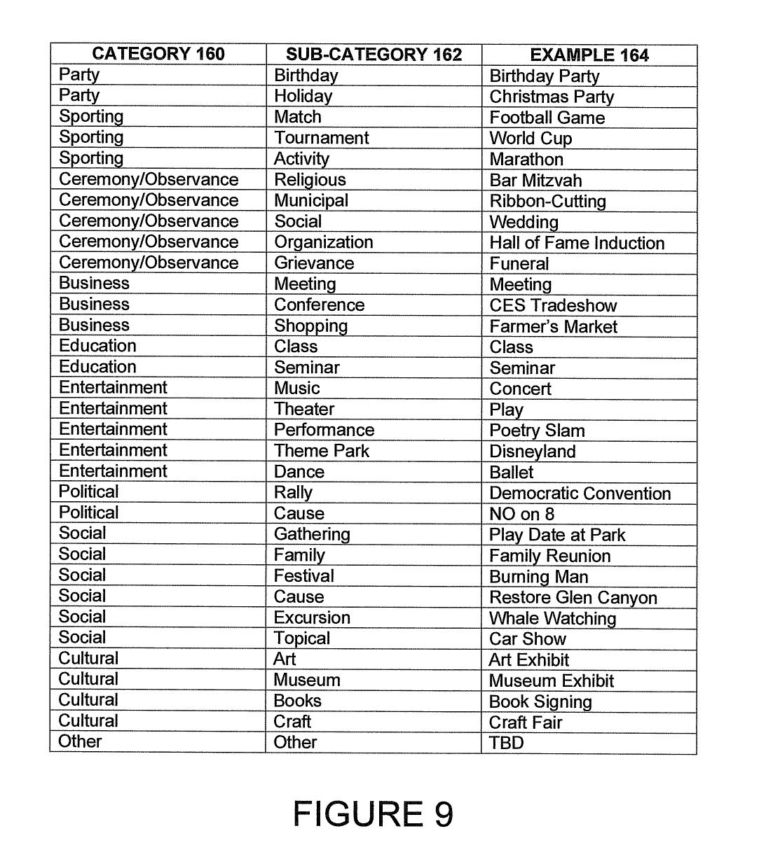

In addition, an event may be defined by short, descriptive terms such as categories 160 and sub-categories 162. FIG. 9 is a table showing (without limitation) various examples of such categories 160 and sub-categories 162, as well as examples 164 of events that would be described by such categories and sub-categories. Referring to FIG. 9, a “Football Game” event 164 may be classified under the category “Sporting” and the sub-category “Match”. The event “Disneyland” may be classified under the category “Entertainment” and the sub-category “Theme Park”. FIG. 9 shows merely a few examples of the limitless possibilities.

Referring again to FIG. 8, and importantly, the event is defined by a timeframe including a date (or date range) 166, a start time 168 and ending time 170. Once all event details are obtained, the user creates the event by pressing a “launch”, start or any other input button or device to signify that all event details are entered and the user is ready to create the event.

Referring again to FIG. 5, once the user has enter and edited all event details in step 114, the system checks in step 116 to confirm whether the entered data is in proper and acceptable form. For example, the system may check for grammatical errors, data input errors, etc. If the data is well-formed (step 116-Yes), the method proceeds to step 118 to process the event data and to step 120 to post the event to the system, such as by transmitting the event via Internet connection to remote server 122 (preferably cloud-based). Server 122 includes memory or is in communication with appropriate memory for storing created events (such as hard disk 124 and/or database 126), and also includes a microprocessor for processing and creating events, for analyzing metadata of images for correspondence with created events, and so on. The memory, microprocessor and other components of server 122 may be configured in a similar fashion to like components described with reference to FIG. 1. If there is a problem with any of the input event data (step 116-No), the user is returned to step 114 to re-enter the data, or at least the data that was not acceptable or in proper format.

In step 128, once all event details have been obtained, and the event has been posted to the system, a unique event ID (i.e. event ID 66 of metadata 64) associated with the event is generated by server 122. Event ID 66 further facilitates photo sharing by event participants by associating the location/time defined event with a unique ID. The event/event ID may be stored on local disk 130 (such as the local memory of the user's smartphone), and in step 132 the created event is ready to be associated with images taken by participants of the event. Referring again to FIG. 2, the method proceeds from step 52 of creating the event to step 54 of capturing images.

With reference again to FIG. 2, when a user decides to join an existing event (FIG. 2-step 50) rather than create a new event, or when a user wises to view images associated with an already created event (FIG. 2-step 44), a login/registration process such as that shown in FIG. 10 may be required, particularly in the case of a private event. In step 180, a user that desires to participate in an event (post or review images associated with an event) authenticates to the system, such as by entering a pre-registered user name and password on smart phone 150 that is compared with information stored on server 122. Alternatively, the creator of the event may have stored a list of authorized participant names in server 122, which is compared with the name of the user of smart phone 150. Still alternatively, the creator of the event may have provided each authorized participant with a unique code or password (such as the event ID) to participate in the event. If user registration is required and the user is not registered (step 182-No), a user registration process 184 is initiated to enable the user to participate in the event. After successfully logging in or registering, the user may post or review images associated with the event (step 186).

Alternatively, such as for a public event, there may be no login or registration process associated with the event. Any image captured by a user of the application software may be tagged with metadata including location and time, and sent to server 122. Server 122 compares the location and time metadata associated with the image with events created by others that are stored in server 122. If the location metadata falls within the defined geographic perimeter of an event, and the time falls within the defined timeframe of that event, then the image may be tagged with the various other metadata associated with the event (event ID, name, description, etc.), and stored together with that metadata so as to be accessible by other participants in the event. Server 122 may also generate and send a notification to the user that they have participated in the event, including information such as the event name and ID, such that the user can easily search and retrieve all photos associated with the event. In this manner, even if a created event were not publicized (for instance, a public event could be defined to include all pictures taken by users of the application software within a particular park within a particular timeframe), a user not previously aware of the event could still have his photos associated with the event and provided with the ability to access photos taken by others.

For such public events, the application software may include a setting as to whether or not the user wishes his/her photos to be automatically sent to server 122 for event analysis (i.e. some users may prefer to participate only in events of their choosing), or may allow selective posting of photos on a photo-by-photo basis to server 122 for event analysis. In either case, if the location and time metadata sent to server 122 along with the image matches any created public events, the user may be informed that he is participating in one or more matching events, and may be given the option of having his/her photos to be stored and associated with the event. For example, a user of the application software that generally prefers his/her photos to remain private (not accessible by other users) could select a setting that photos should not be sent to the application server unless the user has joined and is participating in an event. However, when that normally private user is present at a public event that he has not created or joined, but nevertheless believes it likely that other users may have created an event and wishes his/her photos to be associated with the event (such as a concert, for example), the user may simply change the setting while he is present at the event such that photos are automatically sent to server 122 and analyzed. Server 122 could then notify the user of all created public events with a geographic perimeter and timeframe encompassing the user's photos, and allows the user to select that his/her photos should be associated with some, all or none of those events. In this regard, the application software may also provide a setting that all photos are not only automatically sent to server 122, but are also automatically associated with any matching events and stored.

Still alternatively, rather than sending photos and associated metadata to server 122 the application software could instead periodically (or not, at the user's option) transmit the location (GPS data) of mobile device 10 to server 122. Based on this information, server 122 can determine whether the user is present within any public events, and if so, provide an appropriate notification to mobile device 10 of the event and ask whether the user wishes to participate.

1. A non-transitory computer-readable storage medium with an executable program stored thereon that instructs a microprocessor to perform the following steps:
create and store an event that is defined at least by a geographic perimeter and a timeframe;
compare location metadata and time metadata of an image to the geographic perimeter and the timeframe of the event; and
associate the image with the event when the location metadata and time metadata of the image falls within the geographic perimeter and the timeframe of the event.

2. The non-transitory computer-readable storage medium of claim 1, wherein the event is further defined by at least one of a name, a description and an event ID.

3. The non-transitory computer-readable storage medium of claim 1, wherein the event is further defined by a classification of private or public.

4. The non-transitory computer-readable storage medium of claim 3, wherein the image is associated with a private event only if the image was taken by an authorized participant in the event.

5. The non-transitory computer-readable medium of claim 1, wherein the executable program is a mobile application executing on a smartphone or tablet computer.

6. A smartphone comprising:
a touch screen;
the microprocessor of claim 1; and
the non-transitory computer-readable storage medium of claim 1.

7. The smartphone of claim 6, wherein the geographic perimeter is defined based on user input of an encircled geographic location on the touchscreen.

8. A system comprising:
the non-transitory computer-readable storage medium of claim 1; and
a server that performs the steps of comparing the location metadata and time metadata and associating the image with the event.

9. A method of photo sharing comprising the following steps:
storing an event that is defined at least by a geographic perimeter and a timeframe;
associating, using a microprocessor operating on a mobile device, location metadata and time metadata with an image captured by the mobile device;
comparing the location metadata and time metadata associated with the image with the geographic perimeter and the timeframe of the event; and
associating the image with the event when the location metadata and time metadata of the image falls within the geographic perimeter and the timeframe of the event

10. The method of claim 9, further comprising:
obtaining the geographic perimeter and the timeframe of the event by user input to the mobile device.

11. The method of claim 10, wherein the user input of the geographic perimeter of the event is an encircled geographic location on a touch screen of the mobile device.

12. The method of claim 9, further comprising:
allowing access to an image associated with the event only to authorized participants of the events.

13. A method of event notification comprising the following steps:
storing, in a non-transitory computer-readable storage medium, an event that is defined at least by a geographic perimeter and a timeframe;
comparing, using a microprocessor, location metadata and time metadata received from a mobile device with the geographic perimeter and the timeframe of the event; and
notifying the mobile device of the event when the location metadata and time metadata received from the mobile device fall within the geographic perimeter and the timeframe of the event.

14. The method of claim 13, wherein the location and time metadata are received from the mobile device in response to a query sent to the mobile device.

15. The method of claim 13, wherein the location and time metadata are included with an image taken by and received from the mobile device.
